(19) United States
(12) Patent Application Publication
(10) Pub. No.: US 2014/0313005 A1
(43) Pub. Date: Oct. 23, 2014

(54) COMMON MODE FILTER AND METHOD OF MANUFACTURING THE SAME

(71) Applicant: SAMSUNG ELECTRO-MECHANICS CO., LTD., Suwon-si (KR)

(72) Inventors: Hye Won BANG, Suwon-si (KR); Young Seuck YOO, Suwon-si (KR); Young Do KWEON, Suwon-si (KR); Sung Kwon WI, Suwon-si (KR); Kang Heon HUR, Suwon-si (KR)

(73) Assignee: SAMSUNG ELECTRO-MECHANICS CO., LTD., Suwon-si (KR)

(21) Appl. No.: 14/255,628

(22) Filed: Apr. 17, 2014

(30) Foreign Application Priority Data
Apr. 18, 2013 (KR) 10-2013-0042956

(51) Int. Cl. H01F 27/28; H01F 41/04; H01F 41/34

(52) U.S. Cl. CPC H01F 27/2804; H01F 41/34; H01F 41/041
USPC 336/200; 29/600

(57) ABSTRACT

Disclosed herein is a common mode filter capable of increasing a thickness of the coil electrode in a more simple and stable scheme. The common mode filter includes: a magnetic substrate; a coil electrode formed on one surface of the magnetic substrate and enclosed by an insulating resin; and external electrode terminals connected to both ends of the coil electrode, wherein the coil electrode includes a first metal pattern layer and a second metal pattern layer formed on the first metal pattern layer by performing electroplating using the first metal pattern layer as a lead wire.

### CROSS REFERENCE(S) TO RELATED APPLICATIONS

This application claims the benefit under 35 U.S.C. Section 119 of Korean Patent Application Serial No. 10-2013-0042956, entitled “Common Mode Filter and Method of Manufacturing the Same” filed on Apr. 18, 2013, which is hereby incorporated by reference in its entirety into this application.

### BACKGROUND OF THE INVENTION

1. Technical Field

The present invention relates to a common mode filter and a method of manufacturing the same, and more particularly, to a structure of a coil electrode included in a common mode filter.

2. Description of the Related Art

In accordance with the development of a technology, electronic devices such as a portable phone, a home appliance, a personal computer (PC), a personal digital assistant (PDA), a liquid crystal display (LCD), and the like, have been changed from an analog scheme into a digital scheme and a speed of the electronic devices has increased due to an increase in an amount of processed data. Therefore, a universal serial bus (USB) 2.0, a USB 3.0, and a high-definition multimedia interface (HDMI) have been widely spread as a high speed signal transmitting interface and have been used in many digital devices such as a personal computer and a digital high-definition television.

These interfaces adopt a differential signal system transmitting differential signals (differential mode signals) using a pair of signal lines unlike a single-end transmitting system that has been generally used for a long period of time. However, electronic devices that are digitized and have an increased speed are sensitive to stimulus from the outside. That is, in the case in which a small abnormal voltage and high frequency noise are introduced from the outside into an internal circuit of the electronic device, a circuit may be damaged and a signal may be distorted.

In order to prevent the damage to the circuit of the electronic device and generation of the signal distortion, a filter is installed to prevent the abnormal voltage and the high frequency noise from being introduced into the circuit. Generally, a common mode filter has been used in a high speed differential signal line, or the like, in order to remove common mode noise.

The common mode noise indicates noise generated in the differential signal line, and the common mode filter removes noise that may not be removed by an existing electromagnetic interference (EMI) filter. The common mode filter contributes to improvement in EMI characteristics of a home appliance, or the like, and improvement of antenna characteristics of a cellular phone, or the like.

A general structure of the common mode filter will be described with reference to Japanese Patent Laid-Open Publication No. 2012-015494. The common mode filter has a structure in which a pair of primary and secondary coil electrodes is disposed in an insulating layer and is spaced apart from each other while having an insulating resin therebetween, wherein the insulating resin configures the insulating layer. The common mode filter having the above-mentioned structure may be manufactured by repeatedly forming the insulating resins and the coil electrodes by a build-up process.

Next, a process of forming the coil electrode will be described in detail. First, a copper seed layer is plated on a magnetic substrate and resist patterns are bonded to the copper seed layer. Then, a metal is increased on the copper seed layer exposed between the resistor patterns in a plating scheme or a depositing scheme. Thereafter, the resistor patterns are stripped, and the copper seed layer at a portion to which the resistor patterns are bonded is removed.

Meanwhile, in accordance with miniaturization of a product, a coil electrode in which an interval between the patterns is narrow and a thickness of the patterns is thick has been demanded in order to decrease insertion loss of the common mode filter. Therefore, in the process of forming the coil electrode as described above, the coil electrode has been formed so that the resist patterns bonded to the copper seed layer have a wide width and a thick thickness.

In this case, exposure and development conditions should be enhanced so that a resist is hardened from an upper portion thereof up to a lower portion thereof in a photolithography process for forming patterns on the resist. However, since the thickness of the resist is thick, the upper portion of the resist is excessively hardened and the lower portion thereof is relatively less hardened. Therefore, the lower portion of the resist is over-developed in a developing process, such that an undercut may be generated. As a result, there is a problem that the resist patterns collapse.

In addition, even though the resist patterns are formed without collapse, in a process of removing the copper seed layer after stripping the resist patterns, an etching solution does not smoothly flow between the patterns of the coil electrode due the coil electrode in which the interval between the patterns is narrow and the thickness of the patterns is thick, such that the copper seed layer may not be etched. This finally causes a short-circuit phenomenon between the patterns of the coil electrode.

### RELATED ART DOCUMENT

### Patent Document

(Patent Document 1) Japanese Patent Laid-Open No. 2012-015494

### SUMMARY OF THE INVENTION

An object of the present invention is to provide a common mode filter capable of solving an undercut or a short-circuit occurring in a manufacturing process according to the related art by manufacturing a coil electrode so as to have a thick thickness in a reliable scheme, and a method of manufacturing the same.

According to an exemplary embodiment of the present invention, there is provided a common mode filter including: a magnetic substrate; a coil electrode formed on one surface of the magnetic substrate and enclosed by an insulating resin; and external electrode terminals connected to both ends of the coil electrode, wherein the coil electrode includes a first metal pattern layer and a second metal pattern layer formed on the first metal pattern layer by performing electroplating using the first metal pattern layer as a lead wire.

The first metal pattern layer may be formed by a subtractive method, an additive method, or a semi-additive method.

The second metal pattern layer may have a pattern width smaller than that of the first metal pattern layer.

The coil electrode may include primary and secondary coil electrodes stacked while having the insulating resin therebetween.

The common mode filter may further include: lower surface electrode terminals formed over the coil electrode and connected to the external electrode terminals; and a magnetic composite formed between the lower surface electrode terminals.

According to another exemplary embodiment of the present invention, there is provided a method of manufacturing a common mode filter, including: plating a first metal pattern layer on one surface of a magnetic substrate; applying an insulating resin so as to cover the first metal pattern layer; drilling a hole in the insulating resin to expose an upper surface of the first metal pattern layer, the hole having the same pattern as that of the first metal pattern layer; performing electroplating using the first metal pattern layer as a lead wire to form a second metal pattern layer in the hole; and applying an insulating resin so as to cover the second metal layer.

In the plating of the first metal pattern layer, a subtractive method, an additive method, or a semi-additive method may be used.

In the drilling of the hole, the hole may be drilled so as to have a width smaller than a pattern width of the first metal pattern layer.

In the performing of the electroplating, a current may be applied to a plating line connected to one end of the first metal pattern layer and formed at an outer side of the magnetic substrate.

The plating line may be plated together with the first metal pattern layer at the time of plating the first metal pattern layer and be removed after the second metal pattern layer is formed.

The method may further include, before the plating of the first metal pattern layer, applying an insulating resin onto one surface of the magnetic substrate.

External electrode terminals connected to both ends of the first metal pattern layer may be plated together with the first metal pattern layer at the time of plating the first metal pattern layer, be exposed together with the first metal pattern layer in the drilling of the hole, and be then plated and grown by the electroplating.

### BRIEF DESCRIPTION OF THE DRAWINGS

FIG. 1 is a perspective view of a common mode filter according to an exemplary embodiment of the present invention;

FIG. 2 is a cross-sectional view taken along the line I-I′ of FIG. 1;

FIGS. 3 to 7 are views sequentially showing processes of a method of manufacturing a common mode filter according to the exemplary embodiment of the present invention; and

FIG. 8 is a view showing an example of a plating line according to the exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

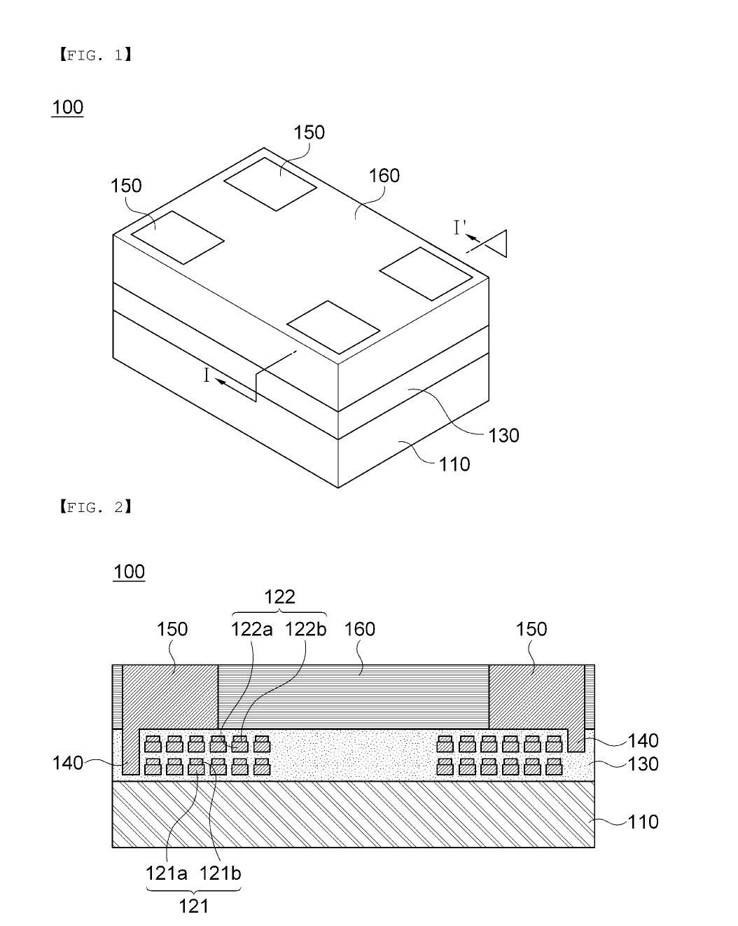

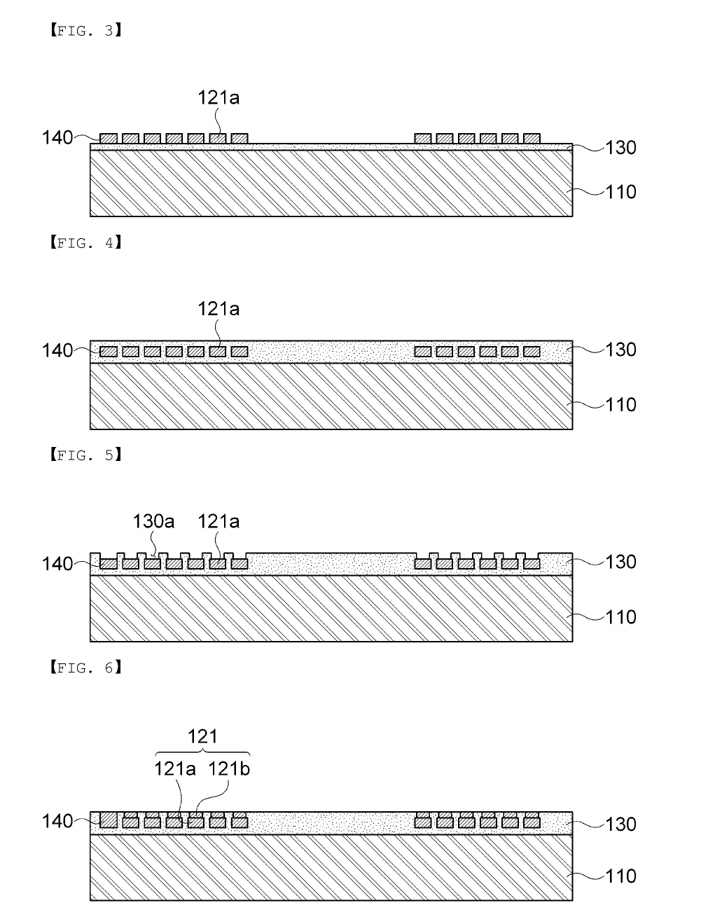

FIG. 1 is a perspective view of a common mode filter according to an exemplary embodiment of the present invention; and FIG. 2 is a cross-sectional view taken along the line I-I′ of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention. Meanwhile, throughout the accompanying drawings, the same reference numerals will be used to describe the same components. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

Referring to FIGS. 1 and 2, the common mode filter 100 according to the exemplary embodiment of the present invention may be configured to include a magnetic substrate 110, primary and secondary coil electrodes 121 and 122 formed on one surface of the magnetic substrate 110 and enclosed by an insulating resin 130, and external electrode terminals 140 connected to both ends of the primary and secondary coil electrodes 121 and 122, respectively. In addition, the common mode filter 100 according to the exemplary embodiment of the present invention may further include lower surface electrode terminals 150 formed on the coil electrodes 121 and 122 and bonded to the respective external electrode terminals 140 and a magnetic composite 160 formed between the lower surface electrode terminals 150.

The magnetic substrate 110 and the magnetic composite 160 may be made of Ni-Zn, Mn-Zn based ferrite, Ni-Zn based ferrite, Ni-Zn-Mg based ferrite, Mn-Mg-Zn based ferrite, or a mixture thereof having high electrical resistance and low magnetic loss and capable of easily designing impedance through a composition change in order to make a flow of a magnetic flux generated in the coil electrodes 121 and 122 at the time of applying a current. In addition, since the magnetic composite 160 is filled and formed in a paste form between the lower surface electrode terminals 150 after the lower surface electrode terminals 150 are completed, it may contain an epoxy resin, an organic binder, and the like, in addition to a magnetic material.

A material configuring the insulating resin 130 enclosing primary and secondary coil electrodes 121 and 122 may be appropriately selected in consideration of an insulating property, heat resistance, moisture resistance, and the like. For example, an example of an optimal polymer material configuring the insulating resin 130 may include a thermosetting resin such as an epoxy resin, a phenol resin, a urethane resin, a silicone resin, a polyimide resin, or the like, and a thermoplastic resin such as a polycarbonate resin, an acrylic resin, a polyacetal resin, a polypropylene resin, or the like.

The primary and secondary coil electrodes 121 and 122 are spaced apart from each other by a predetermined gap while having the insulating resin 130 therebetween, to thereby be electromagnetically coupled to each other, and are plated in a spiral form on the same plane. Alternatively, the primary and secondary coil electrodes 121 and 122 may also be alternately arranged and plated on the same layer. The number of each of the primary coil electrodes 121 and the secondary coil electrodes 122 may be plural, and the plurality of primary coil electrodes 121 or the plurality of secondary coil electrodes 122 may be stacked in a thickness direction while having the insulating resin 130 therebetween, to thereby be electrically interconnected.

The primary and secondary coil electrodes 121 and 122 disclosed in the present invention have the same shape and perform the same function. Therefore, hereinafter, the primary coil electrode 121 will be mainly described for convenience of explanation. The following description for the primary coil electrode 121 is similarly applied to the secondary coil electrode 122.

More specifically, the primary coil electrode 121 includes a first metal pattern layer 121a and a second metal pattern layer 121b formed on the first metal pattern layer 121a by performing electroplating using the first metal pattern layer 121a as a lead wire.

That is, the first metal pattern layer 121a, which is a lower metal layer of the primary coil electrode 121, has the same patterns as those of the primary coil electrode 121. The first metal pattern layer 121a may be formed on the magnetic substrate 110 by a generally known plating method such as a subtractive method, an additive method, a semi-additive method, or the like.

The second metal pattern layer 121b may be formed by performing the electroplating using the first metal pattern layer 121a manufactured as described above as the lead wire. Here, the second metal pattern layer 121b may be formed to have a pattern width smaller than that of the first metal pattern layer 121a so that it is matched to the first metal pattern layer 121a. Next, a method of manufacturing the coil electrode having the structure as described above will be described.

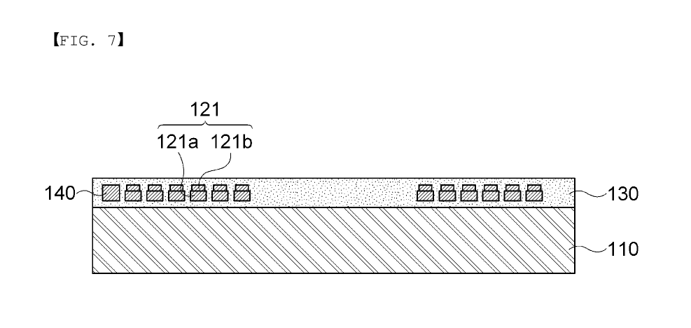

FIGS. 3 to 7 are views sequentially showing processes of a method of manufacturing a common mode filter according to the exemplary embodiment of the present invention. In order to manufacture the coil electrode having the structure as described above, the first metal pattern layer 121a is first plated on one surface of the magnetic substrate 110 as shown in FIG. 3.

Since the first metal pattern layer 121a becomes the lower metal layer of the finally completed primary coil electrode 121 as described above, the first metal pattern layer 121a is plated to have the same patterns as those of the finally completed primary coil electrode 121. As a method of plating the first metal pattern layer 121a, a subtractive method, an additive method, a semi-additive method, or the like, that are generally known may be used. Therefore, there may also be a copper seed layer (not shown) under the first metal pattern layer 121a according to a plating method.

The external electrode terminals 140 connected to both ends of the first metal pattern layer 121a may be plated together with the first metal pattern layer 121a at the time plating the first metal pattern layer 121a. In addition, in order to electrically insulate the first metal pattern layer 121a and the external electrode terminals 140 from the magnetic substrate 110, the insulating resin 130 may be applied onto one surface of the magnetic substrate 110, and the first metal pattern layer 121a and the external electrode terminals 140 may be plated on the applied insulating resin 130.

After the first metal pattern layer 121a is plated on one surface of the magnetic substrate 110 as described above, the insulating resin 130 is applied so as to cover the first metal pattern layer 121a as shown in FIG. 4, and a hole 130a is drilled in the insulating resin 130 as shown in FIG. 5.

The hole 130a may be drilled by a photolithography process and be drilled depending on the pattern of the first metal pattern layer 121a. Therefore, as shown in FIG. 5, an upper surface of the first pattern layer 121a may be exposed to the outside through the hole 130a.

Here, the hole 130a may be formed so as to have a width smaller than the pattern width of the first metal pattern layer 121a so that it may be matched to the second metal pattern layer 121b.

After the hole 130a is drilled, the electroplating is performed using the first metal pattern layer 121a as the lead wire to form the second metal pattern layer 121b filled in the hole 130a. That is, the second metal pattern layer 121b is formed by plating and growing the first metal pattern layer 121a, and the first and second metal pattern layers 121a and 121b may be made of the same metal.

In order to connect the external electrode terminal 140 and the lower surface electrode terminal 150 to each other, the external electrode terminal 140 is exposed together with the first metal pattern layer 121a at the time of drilling the hole and is then plated and grown by the electroplating. Similar to the first and second metal pattern layers 121a and 121b, a metal increased by the electroplating at the external electrode terminal 140 is distinguished from a lower metal. However, the metal increased by the electroplating at the external electrode terminal and the lower metal are shown integrally with each other in FIGS. 3 to 7 so as to be consistent with FIG. 2.

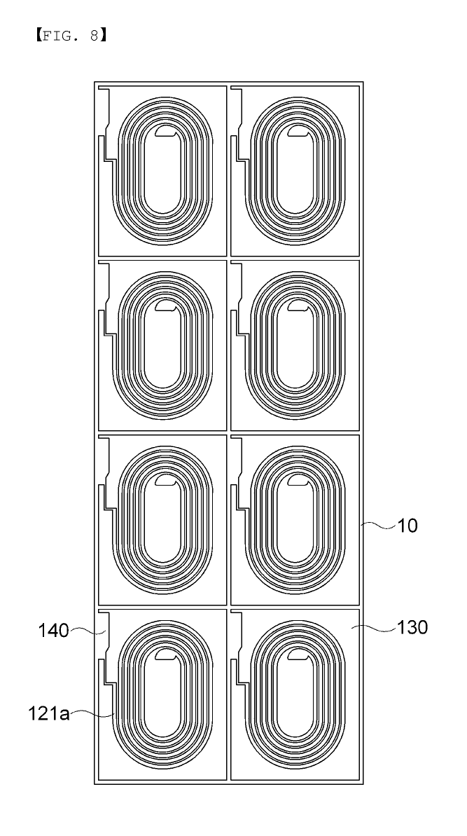

The electroplating may be performed by applying a current to a plating line connected to one end of the first metal pattern layer 121a and formed at an outer side of the magnetic substrate 110. FIG. 8, which is a view showing an example in which the plating line is formed, shows the magnetic substrate viewed from the top after the first metal pattern layer 121a is plated.

As shown in FIG. 8, after a magnetic substrate having a predetermined size is prepared for mass production, it is divided into several sections and the subsequent processes are performed for each section. Meanwhile, the plating line 10 is formed at the outer side of each section and is connected to one end of the first metal pattern layer 121a plated in each section, more specifically, the external electrode terminal 140 connected to one end of the first metal pattern layer 121a. Therefore, when the magnetic substrate subject to the processes shown in FIGS. 4 and 5 is put into a plating bath in which a plating solution is filled and a current is then applied to the magnetic substrate through the plating line 10, a metal is grown on the first metal pattern layer 121a, such that the second metal pattern layer 121b may be formed in the hole 130a.

Here, the plating line 10 may be plated together with the first metal pattern layer 121a at the time of plating the first metal pattern layer 121a and be removed in a dicing scheme or a cutting scheme after the second metal pattern layer 121b is formed.

After the primary coil electrode 121 is completed by forming the second metal pattern layer 121b, the insulating resin 130 is applied so as to cover the second metal pattern layer 121b as shown in FIG. 7, and the processes shown in FIGS. 3 to 7 are repeatedly performed, thereby making it possible to form the secondary coil electrode 122 including the first metal pattern layer 122a and the second metal pattern layer 122b.

Finally, after the lower surface electrode terminals 150 bonded to the respective external electrode terminals 140 are plated on an upper surface of the insulating resin 130, a magnetic paste is filled and hardened between the lower surface electrode terminals 150 to form the magnetic composite 160, such that the common mode filter 100 according to the exemplary embodiment of the present invention may be finally completed.

As described above, with the method of manufacturing a common mode filter according to the exemplary embodiment of the present invention, the first metal pattern layer is used as a basic layer and the second metal pattern layer is formed on the first metal pattern layer by additional plating, thereby making it possible to more simply and stably increase a thickness of the coil electrode.

With the common mode filter and the method of manufacturing the same according to the exemplary embodiment of the present invention, the thickness of the coil electrode is increased in a reliable manufacturing scheme, thereby making it possible to increase stability of a product and significantly decrease insertion loss of the common mode filter.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A common mode filter comprising:
a magnetic substrate;
a coil electrode formed on one surface of the magnetic substrate and enclosed by an insulating resin; and
external electrode terminals connected to both ends of the coil electrode,
wherein the coil electrode includes a first metal pattern layer and a second metal pattern layer formed on the first metal pattern layer by performing electroplating using the first metal pattern layer as a lead wire.

2. The common mode filter according to claim 1, wherein the first metal pattern layer is formed by a subtractive method, an additive method, or a semi-additive method.

3. The common mode filter according to claim 1, wherein the second metal pattern layer has a pattern width smaller than that of the first metal pattern layer.

4. The common mode filter according to claim 1, wherein the coil electrode includes primary and secondary coil electrodes stacked while having the insulating resin therebetween.

5. The common mode filter according to claim 1, further comprising:
lower surface electrode terminals formed over the coil electrode and connected to the external electrode terminals; and
a magnetic composite formed between the lower surface electrode terminals.

6. A method of manufacturing a common mode filter, comprising:
plating a first metal pattern layer on one surface of a magnetic substrate;
applying an insulating resin so as to cover the first metal pattern layer;
drilling a hole in the insulating resin to expose an upper surface of the first metal pattern layer, the hole having the same pattern as that of the first metal pattern layer;
performing electroplating using the first metal pattern layer as a lead wire to form a second metal pattern layer in the hole; and
applying an insulating resin so as to cover the second metal layer.

7. The method according to claim 6, wherein in the plating of the first metal pattern layer, a subtractive method, an additive method, or a semi-additive method is used.

8. The method according to claim 6, wherein in the drilling of the hole, the hole is drilled so as to have a width smaller than a pattern width of the first metal pattern layer.

9. The method according to claim 6, wherein in the performing of the electroplating, a current is applied to a plating line connected to one end of the first metal pattern layer and formed at an outer side of the magnetic substrate.

10. The method according to claim 9, wherein the plating line is plated together with the first metal pattern layer at the time of plating the first metal pattern layer and is removed after the second metal pattern layer is formed.

11. The method according to claim 6, further comprising, before the plating of the first metal pattern layer, applying an insulating resin onto one surface of the magnetic substrate.

12. The method according to claim 6, wherein external electrode terminals connected to both ends of the first metal pattern layer are plated together with the first metal pattern layer at the time of plating the first metal pattern layer, are exposed together with the first metal pattern layer in the drilling of the hole, and are then plated and grown by the electroplating.
